(19) United States
(12) Patent Application Publication
(10) Pub. No.: US 2010/0013717 A1
(43) Pub. Date: Jan. 21, 2010

(54) ANTENNA INTEGRATED IN A PRINTED CIRCUIT BOARD

(76) Inventors: Mattias Gustafsson, Goteborg (SE); Emil Wikgren, Skelleftea (SE)

Correspondence Address: ERICSSON INC., 6300 LEGACY DRIVE, M/S EVR 1-C-11, PLANO, TX, 75024, US

(21) Appl. No.: 12/520,761

(22) PCT Filed: Dec. 22, 2006
(86) PCT No.: PCT/SE06/50622

§ 371 Date: Jun. 22, 2009

(51) Int. Cl. H01Q 1/38; H01Q 1/48

(52) U.S. Cl. 343/700 MS; 343/848

(57) ABSTRACT

An antenna for mounting in or on a non-conducting substrate, the antenna comprising a radiation element, a ground plane, coupling means for coupling the ground plane to the radiation element, and feeder means for connecting the antenna to other devices. The radiation element, the ground plane and the coupling means are separated from each other by the substrate, and the radiation element is so shaped and positioned with respect to the ground plane as to define a range of distances between a first edge of the ground plane and a first edge of the radiation element.

### TECHNICAL FIELD

The present invention discloses an antenna for mounting in or on a non-conducting substrate. The antenna comprises a radiation element, a ground plane, coupling means for coupling the ground plane to the radiation element and feeder means for connecting the antenna to other devices. In the antenna, the radiation element, the ground plane and the coupling means are separated from each other by the substrate.

### BACKGROUND

In mobile telecommunications networks, such as cellular telephony networks, there is a growing need for small antennas which can be used in small base stations, i.e. in nodes which are used to control and route all traffic to and from users within a certain area of the network.

Such antennas should preferably be possible to integrate into the base station, thus implying small size as a requirement for the antenna. Other demands on such antennas are, for example, that they should be inexpensive to manufacture, have a good omnidirectional radiation pattern, and that reflection losses in the antenna should be small over the operational bandwidth of the system.

### SUMMARY

The requirements for an antenna described above are addressed by the present invention in that it discloses an antenna for mounting in or on a non-conducting substrate. The antenna comprises a radiation element, a ground plane, coupling means for coupling the ground plane to the radiation element, and feeder means for connecting the antenna to other devices.

In the antenna of the invention, the radiation element, the ground plane and the coupling means are separated from each other by the substrate, and the radiation element is so shaped and positioned with respect to the ground plane as to define a range of distances between a first edge of the ground plane and a first edge of the radiation element.

In a preferred embodiment of the invention, the substrate has a first and a second main surface, and the radiation element and the ground plane are arranged on the first main surface of the substrate, with the coupling means being arranged on the second main surface of the substrate.

Thus, by means of the invention, an antenna is provided which can be integrated into a printed circuit board, a PCB, by using the substrate of the PCB as the substrate on or in which the antenna is mounted. In addition, the bandwidth which it is desired to cover with the antenna can be adjusted by adjusting the range of distances which is defined by the first edges of the ground plane and the radiation element.

Suitably but not necessarily, the ground plane additionally comprises means for matching the impedance of the radiation element, so as to minimize losses.

### BRIEF DESCRIPTION OF THE DRAWINGS

The invention will be described in more detail in the following, with reference to the appended drawings, in which

FIG. 1a shows a schematic top view of a PCB with an antenna according to the invention, and

FIG. 1b shows a detail from FIG. 1a, and

FIG. 2 shows a cross-section of the PCB of FIG. 1, and

FIG. 3 shows an equivalent circuit for an antenna of the invention, and

FIGS. 4-6 show other possible embodiments of the invention, and

FIG. 7 shows an additional alternative embodiment of the invention.

### DETAILED DESCRIPTION

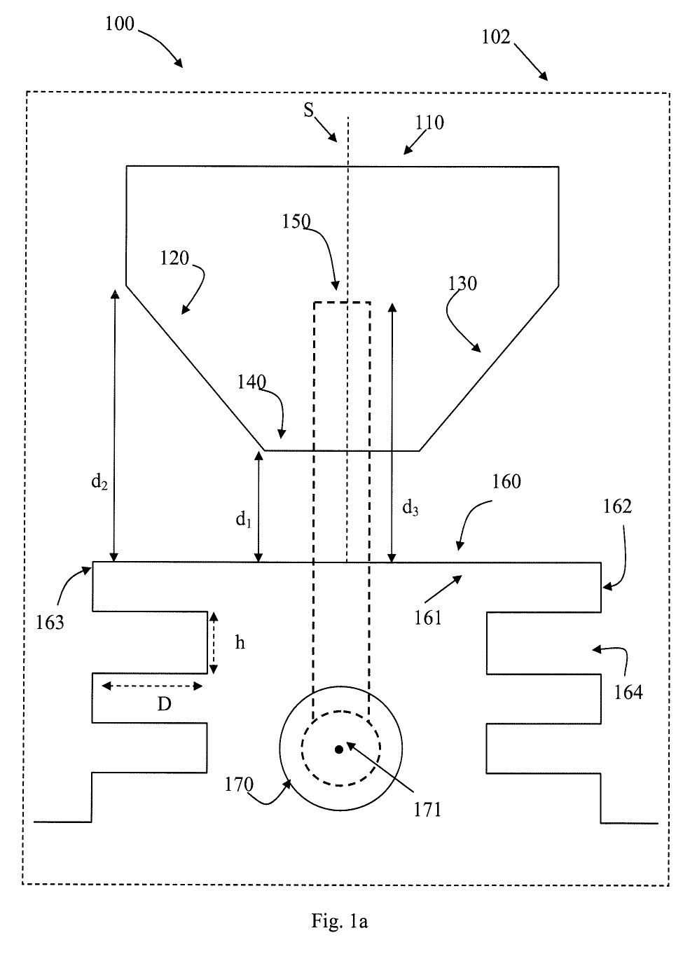

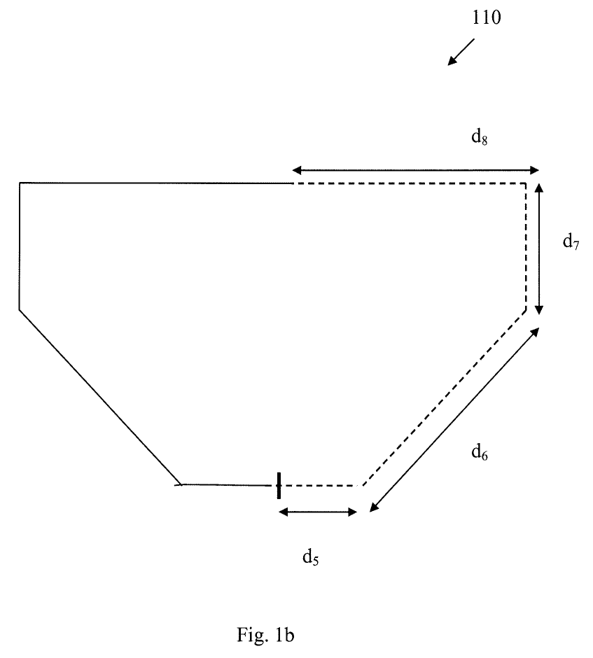

FIG. 1a shows an embodiment 100 of an antenna of the invention. FIG. 1a is a “top view” of the antenna 100, and shows that the antenna is arranged on a non conducting substrate 102, such as for example, the supporting substrate of a printed circuit board, a PCB. The substrate 102 on which the antenna is arranged in the exemplary embodiment of FIG. 1a is essentially flat, i.e. it has a first and a second main surface, the upper surface and the bottom surface.

As shown in FIG. 1a, the antenna 100 comprises a radiation element 110 and a ground plane 160 for the radiation element 110, both of which are made of an electrically conducting material such as, for example, copper. The radiation element 110 and the ground plane 160 are both arranged on the same main surface of the substrate 102.

The antenna 100 also comprises coupling means 150, by means of which the radiation element 110 is coupled to the ground plane 160. In the embodiment shown in FIG. 1a, the coupling means 150 is designed as a “tongue” or strip of conducting material, which is arranged on the opposite main surface of the substrate 102, as compared to the surface on which the radiation element and the ground plane are arranged. This could be expressed as saying that if the radiation element 110 and the ground plane 160 are arranged on the upper surface of the substrate 102, the coupling element 150 will be arranged on the bottom surface of the substrate 102. The location of the strip 150 on the opposite main surface of the substrate 102 as compared to the ground plane 160 and the radiation element 110 is also indicated by the use of dashed lines to show the strip 150.

Thus, the radiation element 110 is coupled capacitively to the ground plane 160 by means of the strip 150 which is located on the opposite side of the substrate 102.

As can be seen in FIG. 1a, the radiation element 110 is so arranged and designed that a range of distances d₁-d₂ is defined from an edge 120, 130, of the radiation element 110 to an edge 161 of the ground plane 160. The reason for this will be explained later in this text, with reference to FIG. 1b.

The range of distances d₂-d₁ between the ground plane 160 and the radiation element 110 can be achieved in a number of ways, one of which is shown in FIGS. 1a and 1b: the ground plane 160 has a first edge which comprises a straight line 161, and the radiation element has at least a first edge 120 which comprises a straight line. The first edge 120 of the radiation element is arranged at an angle, i.e. obliquely, with respect to an imagined line S which extends perpendicularly from the first edge 161 of the ground plane 160, thereby defining said range of distances d₂-d₁.

As can be seen in FIG. 1a, d₁ is the shortest distance between the edge of the radiation element 110 that faces the ground plane, and d₂ is the longest such distance.

Also shown in FIG. 1a is that in a preferred embodiment, the radiation element 110 of the antenna 100 is symmetrical with respect to the imagined line S. Thus, in the preferred embodiment shown, the radiation element comprises two edges 120, 130, which both extend obliquely in the manner described above, with one edge extending in either direction from the line S. The two edges 120, 130, are also interconnected by a short section 140 which extends in parallel to the straight edge 161 of the ground plane 160.

In order to minimize losses in the antenna 100, the antenna also comprises means for matching the impedance of the radiation element 110. In a preferred embodiment, the matching means comprise a number of grooves or tracks 164 in the ground plane 160. If the ground plane has a rectangular shape, so that there are two side edges 162, 163, of the ground plane, the grooves will extend inwards from these side edges 162, 163, with a certain depth D and height h.

It should be pointed out here that the grooves shown in FIG. 1 are merely one example of such grooves, it is entirely possible, for example, to let the grooves extend into the ground plane from a side of the ground plane which faces the radiation element 110.

More will be said about the matching function of the grooves 164 later on in this document, but another important function of the grooves which should be mentioned is that they inhibit ground plane currents.

As is also shown in FIG. 1a, the antenna 100 comprises feeder means 170, 171, for connecting the antenna to other devices and thereby making it possible to supply the antenna with signals for transmission and to supply other devices with signals which have been received by the antenna 100.

The feeder means can be designed in a variety of ways which are well known to the man skilled in the field, but one possible design is shown in FIG. 1a: a coaxial contact is arranged on the ground plane 160, one part 170 of which is an outer ring which is connected to the ground plane, and the other part of which is a pin 171 which is connected to the strip 150, and which extends through the substrate 102, up through the ground plane without making galvanic contact with the ground plane.

Turning now to FIG. 1b, the radiation element 110 is shown on its own. FIG. 1b is intended to illustrate the reason for the range of distances d₂-d₁ exhibited by invention. In FIG. 1b, a number of distances d₅-d₈ are shown, intended to illustrate a distance which is also shown in the radiation element 110 as such by means of dashed lines: the sum of the distances d₅-d₈ is half of the circumference of the radiation element 110. This distance, i.e. half of the circumference of the radiation element will determine the approximate centre frequency of the operating bandwidth of the antenna 100.

As can be realized, by varying the distances d₂ and d₁, the circumference of the body or radiation element 110 can be varied, and thus the operating bandwidth of the antenna 100 will be moved in the frequency plane. The total bandwidth of the antenna 100, will be determined, inter alia, by the size of the radiation element 110.

It can also be pointed out that although in a preferred embodiment, the range of distances defined by d₂ and d₁ is chosen such that the first distance d₂ is significantly much longer than the second distance d₁, a range of distances which is such that d₂ and d₁ are equal will also lead to a functioning antenna.

When discussing the shape of the radiation element 110, it can also be mentioned that the size of the radiation element can be used to vary the gain of the antenna, and the shape (rectangular, round, etc) can be used to determine the performance of the antenna over the operational bandwidth.

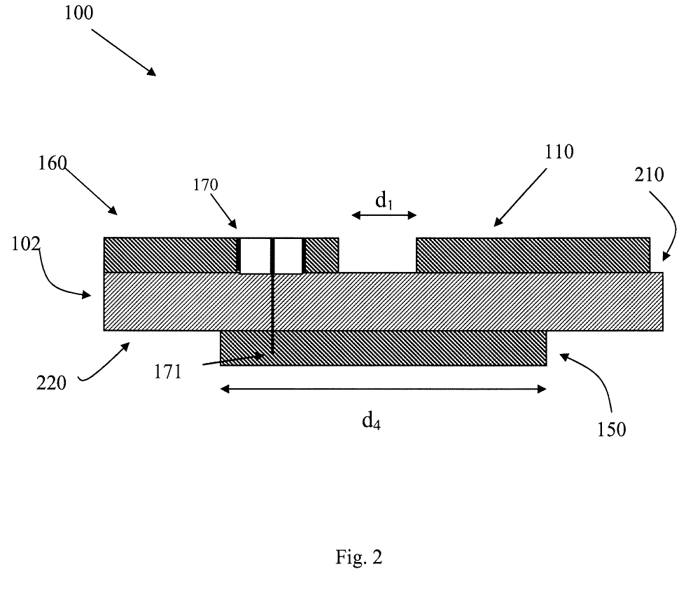

FIG. 2 shows a cross sectional view of the antenna of FIG. 1 along the line S in FIG. 1a. Thus, components which are shown in both FIG. 1 and FIG. 2 have been given the same reference numbers.

As has been described in connection with FIG. 1, but as can be seen more clearly in FIG. 2, the antenna 100 comprises a layer on a first main surface 210 of a non conducting substrate 102, and also a layer on the second main surface of the same substrate. In FIG. 2, the first main surface 210 of the substrate 102 and the second main surface 220 of the substrate 102 can be seen more clearly than in FIG. 1.

The antenna layer on the first main surface 210 of the substrate 102 comprises the radiation element 110 and the ground plane 160, which are arranged at a closest distance d₁ from each other. The antenna layer on the second main surface 220 of the substrate 102 comprises the strip 150, which couples the radiation element to the ground plane capacitively.

Also shown in FIG. 2 are the feeder means, which comprise the outer ring 171 of a coaxial contact, said ring being galvanically connected to the ground plane 160, and the pin 170, which is galvanically connected to the strip 150, and which extends upwards through the substrate 102, and through the ground plane 160, however without contacting the ground plane. Thus, a small section of the ground plane needs to be removed in order to allow the pin 171 to extend in the desired manner.

As can also be seen in FIG. 2, the strip 150 has a longitudinal extension referred to as d₄.

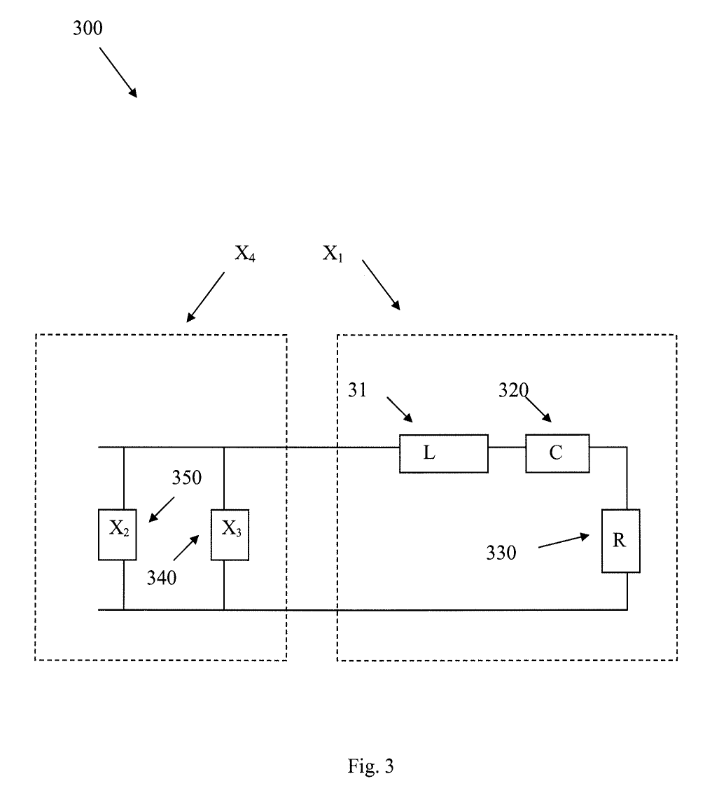

Turning now to FIG. 3, another aspect of the invention is illustrated: FIG. 3 is an equivalent circuit of the antenna 100, which shows that the radiation element 110 in combination with the ground plane 160 can be seen as comprising an inductance L, 310, a capacitance C, 320, and a resistance R, 330. These together can be seen as an impedance, referred to as X₁, which comprises a real and an imaginary component, so that X₁=ReX₁+j*Im X₁

The impedance X₁ can be matched to the impedance of connecting devices, i.e. to a desired impedance, by means of the tracks or grooves 164 and the strip 150. The grooves 164 are shown as a first parallel impedance X₂, 350, and the strip is shown as a second parallel impedance X₃, 340. The combination of X₂ and X₃ can be seen as an impedance X₄ which comprises a real and an imaginary component, so that X₄=ReX₄+j*Im X₄.

In order to achieve ideal matching of the antenna 100, the following criteria should be fulfilled:

1/ImX₁=−1/ImX₄

In order to achieve the desired result which is shown in the equation above, a number of design parameters are available, such as:
The depth and height of the grooves 164, shown as D and h in FIG. 1
The distance of the grooves from the radiation element 110
The length d₄ of the strip 150.

When it comes to using the length of the strip 150 as a tuning parameter, it can be kept in mind that the distance shown as d₃ in FIG. 1, i.e. the distance from the edge of the ground plane 160 to the end of the strip 150 beneath the radiation element 110 should be kept approximately at a value of λ/4, where λ is the centre wavelength of the desired operational bandwidth of the antenna 100. However, the distance d₃ can be varied somewhat around the value of λ/4, in order for it to be used as a tuning factor.

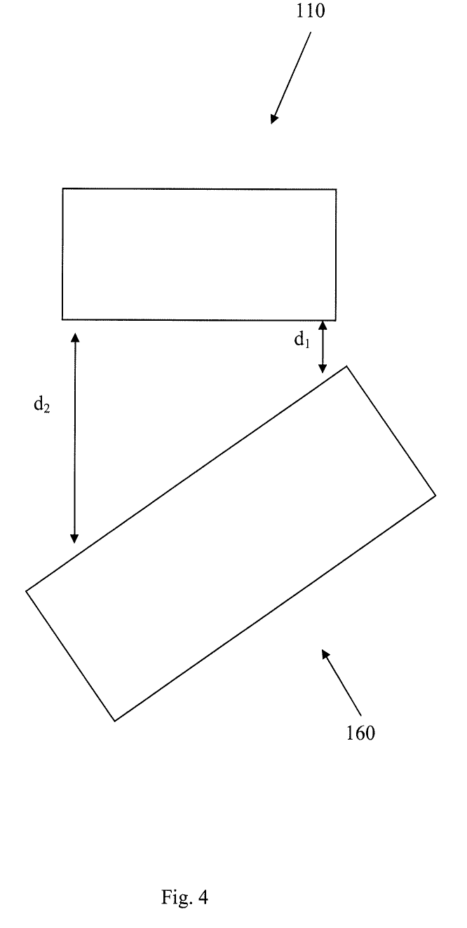

The embodiment of an antenna of the invention shown in FIG. 1 is one example of the invention. Various other variations can be used within the scope of the invention, some of which are shown in FIGS. 4-6. In order to facilitate the understanding of FIGS. 4-6, the reference numbers from FIG. 1 have been used for corresponding components in FIGS. 4-6.

FIG. 4 shows a possible variation of the invention in which the ground plane 160 and the radiation element 110 both are shaped as rectangles, which are obliquely positioned relative to one another, thereby creating the range of distances d₂-d₁.

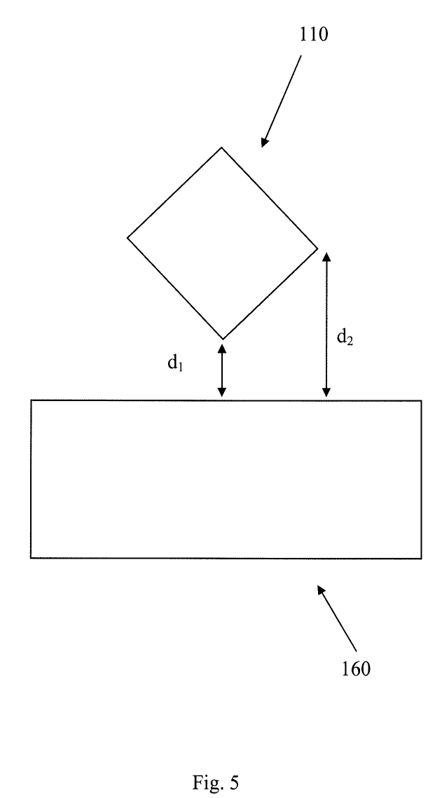

FIG. 5 shows another possible variation of the invention, in which the ground plane 160 and the radiation element 110 both are shaped as rectangles, but in which the radiation element 110 is positioned with one corner pointing towards the straight edge of the ground plane, so that the shortest distance between the radiation element and the ground plane is the distance to the corner of the radiation element.

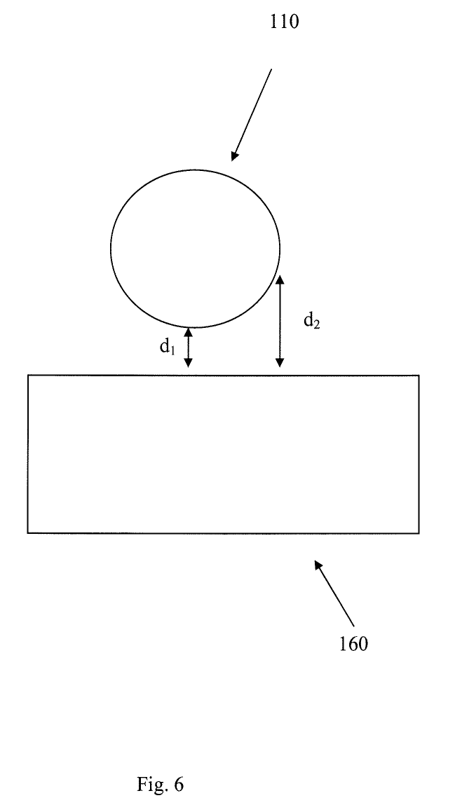

In FIG. 6, yet another possible variation is shown: the radiation element 110 (as well as the ground plane 160) does not need to be rectangular, but can instead be shaped as shown in FIG. 6, i.e. round, which will also create the range of distances d₂-d₁. As will be realized, the round shape of the radiation element 110 can be varied so that the radiation element instead is oval.

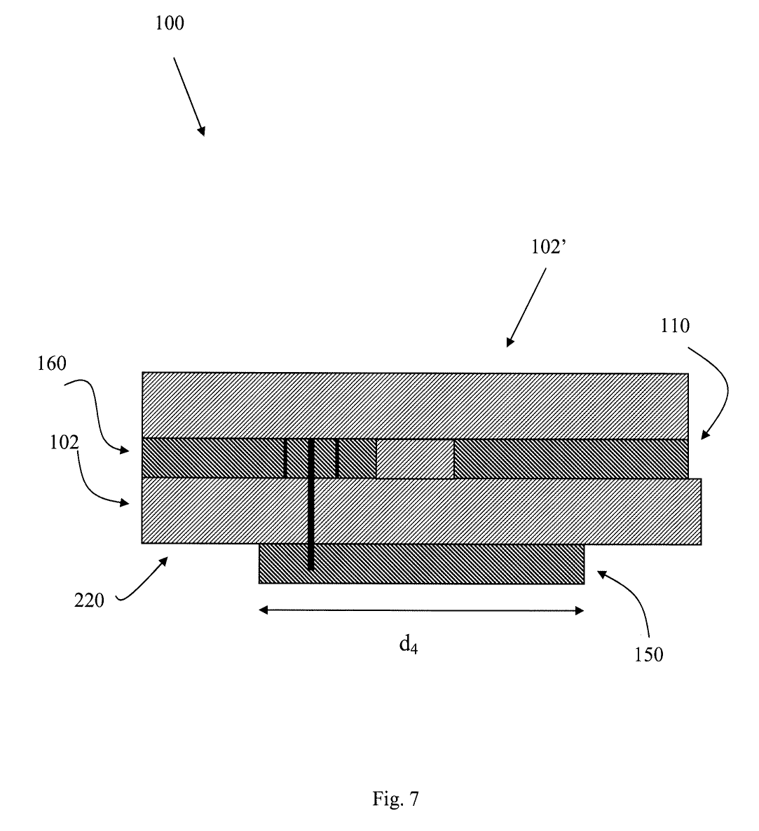

Finally, FIG. 7 shows another embodiment of the invention. The embodiment of FIG. 7 is similar to that of FIG. 2, and similar details have been given similar reference numerals.

The embodiment of FIG. 7 is intended to show another aspect of the invention: in the embodiments described above, the antenna components have been arranged on outside surfaces of the substrate 102. As shown in FIG. 7, one or more of the components can be “embedded” in the substrate 102, as shown in FIG. 7, where there is a second substrate layer 102′ arranged to cover the radiation element 110 and the ground plane 160. Thus, in such an embodiment, one or more of the antenna components may be arranged in the substrate 102, 102′, instead of on it.

In addition, it should be pointed out that the radiation element 110 and the ground plane 160 need not be arranged essentially level with each other, as shown in FIGS. 2 and 7. It is possible to let the radiation element and the ground plane be separated from each other in the same direction that they are shown as being separated from the strip 150, so that they are not level with each other. This can be achieved, for example, by shaping the substrate 102 in a way which gives the desired result.

The invention is not limited to the examples of embodiments described above and in the appended drawings, but may be freely varied within the scope of the appended patent claims.

In order to mention just a few of the many other variations of the invention which are possible, it can be mentioned that the edge of the radiation element which faces the ground plane can also be given a meander shape, so that a variety of distances are created. In addition to this, it is perfectly possible to fold the radiation element and/or the ground plane over an edge, with retained function.

Also, it can be mentioned that the symmetry of the radiation element which has been shown in FIGS. 1-2 and in some of the other variations which have been described above, is not absolutely necessary, but is one way of achieving a good performance of the antenna.

Finally, it should be mentioned that although the embodiments shown in the drawings and described above comprise plane substrates and antenna components, it is entirely possible within the scope of the invention to shape the substrate as a curved plane, and to arrange the antenna components on or in that substrate, so that one or more of the antenna components will also exhibit a correspondingly curved shape.

What is claimed is:

1-8. (canceled)

9. An antenna for mounting in or on a non-conducting substrate, said antenna comprising:
a radiation element;
a ground plane;
coupling means for coupling the ground plane to the radiation element;
feeder means for connecting the antenna to other devices;
wherein the radiation element, the ground plane and the coupling means are separated from each other by the substrate, the radiation element is shaped and positioned with respect to the ground plane so as to define a range of distances (d₂-d₁) between a first edge of the ground plane and a first edge of the radiation element.

10. The antenna of claim 9, wherein the substrate exhibits a first and a second main surface and in which the radiation element and the ground plane are arranged on the first main surface of the substrate and the coupling means are arranged on the second main surface of the substrate.

11. The antenna of claim 9, wherein the ground plane additionally comprises impedance matching means so as to minimize losses.

12. The antenna of claim 9, wherein said first edge of the ground plane comprises a straight line which faces the radiation element and in which the radiation element is symmetrical with respect to an imagined straight line which extends perpendicularly from said first edge of the ground plane.

13. The antenna of claim 11, wherein the matching means of the ground plane comprises a plurality of grooves which extend inwards into the ground plane at a certain depth (D) and height (h).

14. The antenna of claim 13, wherein the grooves extend inwards from side edges of the ground plane which do not face the radiation element.

15. The antenna of claim 12, wherein the first edge of the radiation element comprises a straight line which is parallel to the straight line of the first edge of the ground plane, and also exhibits, on both sides of said first edge, a second edge which is oblique with respect to the first edge of the ground plane.

16. The antenna of claim 9, wherein the range of distances is such that there is a first distance (d₂) and a second distance (d₁) with the first distance being significantly much longer than the second distance.
